(19) United States
(12) Patent Application Publication
(10) Pub. No.: US 2026/0017816 A1
(43) Pub. Date: Jan. 15, 2026

(54) METHOD AND SYSTEM FOR DETECTION OF ROAD OBJECTS USING 2D IMAGE SIGN SIGHTINGS

(71) Applicant: HERE Global B.V., Eindhoven (NL)

(72) Inventors: Nicholas ARMENOFF, Montgomery, IL (US); William ROBINSON, Charlotte, NC (US)

(21) Appl. No.: 18/768,913

(22) Filed: Jul. 10, 2024

(51) Int. Cl. G06T 7/70; G01C 21/36; G06T 7/60; G06V 10/762; G06V 20/58

(52) U.S. Cl. CPC G06T 7/70; G01C 21/3602; G06T 7/60; G06V 10/762; G06V 20/58; G06T 2207/30252; G06V 2201/07

(57) ABSTRACT

The disclosure provides a method, a system, and a computer program product for object detection using 2D sighting data of the object obtained using a 2D sensor. The method comprises obtaining 2D sighting data of the object using the 2D sensor. Further, the method comprises determining position candidate data for the object based on (i) 2D centroid data associated with the 2D sighting data of the object and (ii) 3D centroid data determined using projection data of one or more skew lines associated with the 2D centroid data. The position candidate data is then filtered based on (i) offset data associated with vector offset between the 2D centroid data and the 3D centroid data, (ii) postprocessing data, and (iii) scaling factor data associated with the position candidate data. Further, the detection data for the object is outputted based on the filtered position candidate data.

### TECHNICAL FIELD

The present disclosure relates to object detection, and more particularly relates to object detection of road objects using 2D sighting data.

### BACKGROUND

Object detection is an important task in computer vision for detecting an environment of surrounding a user. The user may be a user of a vehicle using a navigation application. The vehicle is equipped with various sensors which help the vehicle to perceive the environment for performing the object detection.

One important sensor is a light detection and ranging (LiDAR) sensor which uses pulsed laser beams to perceive the environment of the user and detect objects. The measurements of the environment taken by the LiDAR sensor are in the form of point cloud data which gives a three-dimensional (3D) map of the environment which can be used to detect objects in the environment. One important type of object is a road sign, which represents information such as driving restrictions such as speed limits, turn warnings, and overhead clearance warnings, point of interest information, navigational information including details of intersections, exits, and road names, and the like.

Object detection using LiDAR sensors is costly as LiDAR sensors include an expensive LiDAR scanner that is configured to perform object detection and various parameters of the object. Thus, performing LiDAR based object detection early in object detection pipeline is expensive and inefficient.

Based on the foregoing discussion, there exists a need for an efficient system and method that overcomes the above stated disadvantages.

### BRIEF SUMMARY

It is an object of various embodiments of the present disclosure to provide object detection methodologies that are not inherently tied to LiDAR detection. Most of the object detection performed using LiDAR is costly and cannot function without LiDAR. Further, object detection classifiers already in use result in misclassification of objects, making the overall object detection unreliable and error-prone due to probable misclassifications and classifier's uncertainty at longer distances from an object of interest. Therefore, all 3D detection outputs using LiDAR based classifiers are incorrectly assigned to be equally probable treating each classification from a 2D detector/classifier as equally valuable irrespective of the distance of the object of interest from a point of detection and the classifier's inherent uncertainty. This further leads to lower-fidelity output from an object detection pipeline. Additionally, the 3D detection methodologies fail to make use of a detection score and full geometry from a 2D detector which may cause false positives, which is problematic in real time or near-real time applications of object detection.

The present disclosure provides methods and systems for object detection which may be used for near-real-time 3D feature detection without the use of an explicit depth sensor (e.g., LiDAR). The methods and systems disclosed herein provide a 2D-to-2D association mechanism by correcting for an offset between a 2D sighting centroid and the projection of the 3D centroid, and a filtering mechanism for filtering the characteristic false positives that are introduced when depth sensing is removed. Furthermore, the methods and systems provide for a scaling mechanism that may also be adapted for real-time operation.

Example embodiments of the present disclosure provide a method, a system, and a computer program product for object detection using 2D sighting data of an object, without explicit dependence on a depth sensor such as a LiDAR.

In one aspect, a system for detecting an object is disclosed. The system may comprise a memory configured to store computer-executable instructions, and at least one processor configured to execute the computer-executable instructions to obtain, using a 2D sensor, 2D sighting data of the object. The at least one processor is further configured to determine position candidate data for the object based on (i) 2D centroid data associated with the 2D sighting data of the object and (ii) 3D centroid data determined using projection data of one or more skew lines associated with the 2D centroid data. The at least one processor is further configured to filter the position candidate data based on: (i) offset data associated with vector offset between 2D centroid data and the 3D centroid data, (ii) postprocessing data, and (iii) scaling factor data associated with the position candidate data. The at least one processor is further configured to output detection data for the object based on the filtered position candidate data.

In one aspect, a method for detecting an object is provided. The method may comprise obtaining, using a 2D sensor, 2D sighting data of the object. The method may further comprise determining position candidate data for the object based on (i) 2D centroid data associated with the 2D sighting data of the object and (ii) 3D centroid data determined using projection data of one or more skew lines associated with the 2D centroid data. Additionally, the method may comprise filtering the position candidate data based on: (i) offset data associated with vector offset between the 2D centroid data and the 3D centroid data, (ii) postprocessing data, and (iii) scaling factor data associated with the position candidate data. Further, the detection data is output based on the filtered position candidate data.

In yet another aspect, a computer program product comprising a non-transitory computer readable medium having stored thereon computer executable instructions which when executed by at least one processor, cause the processor to carry out operations for detecting an object. The operations may comprise obtaining, using a 2D sensor, 2D sighting data of the object. The operations may further comprise determining position candidate data for the object based on (i) 2D centroid data associated with the 2D sighting data of the object and (ii) 3D centroid data determined using projection data of one or more skew lines associated with the 2D centroid data. Additionally, the operations may comprise filtering the position candidate data based on: (i) offset data associated with vector offset between the 2D centroid data and the 3D centroid data, (ii) postprocessing data, and (iii) scaling factor data associated with the position candidate data. Further, the detection data is output based on the filtered position candidate data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the disclosure in general terms, reference will now be made to the accompanying drawings, which are not necessarily drawn to scale, and wherein:

FIG. 1 illustrates a schematic diagram of a network environment of a system for detecting an object, in accordance with an embodiment of the present disclosure;

FIG. 2A illustrates a block diagram of the system of FIG. 1, in accordance with an embodiment of the present disclosure;

FIG. 2B illustrates an exemplar map database record storing data, in accordance with one or more example embodiments of the present disclosure;

FIG. 2C illustrates another exemplar map database record storing data, in accordance with one or more example embodiments of the present disclosure;

FIG. 2D illustrates another exemplar map database storing data, in accordance with one or more example embodiments of the present disclosure; and

FIG. 3 illustrates a block diagram of a method for detecting an object, in accordance with one or more example embodiments of the present disclosure.

### DETAILED DESCRIPTION

In the following description, for purposes of explanation, numerous specific details are set forth to provide a thorough understanding of the present disclosure. It will be apparent, however, to one skilled in the art that the present disclosure may be practiced without these specific details. In other instances, systems and methods are shown in block diagram form only to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

Object detection using depth sensors such as LiDAR is costly. LiDAR sensors provide detection of objects and object parameters such as one or more of object's position, orientation, and size, but at the cost of an expensive LiDAR scanner. In view of this realization, some embodiments are based on a recognition that it would be advantageous to detect object parameters such as position, orientation, and size, but without the cost of the LiDAR scanner.

Further, some embodiments are based on a recognition that if a LiDAR detection pipeline is available, it would be advantageous to have an option to late-fuse object detection with such LiDAR pipeline.

Accordingly, various embodiments provide a system and a method for object detection based on 2D sighting data associated with 2D sensors. The 2D sighting data is used to identify position candidates for an object and may be used for near-real-time 3D feature detection without the use of an explicit depth sensor (e.g. LiDAR). The 2D sighting data is used to perform 3D feature detection and the position candidates are filtered to remove the characteristic false positives that are introduced when depth sensing is removed. Furthermore, the position candidates are scaled based on a scaling factor to overcome the inaccuracies resulting from long-distance 2D detections.

The methods and systems disclosed in various embodiments may be used in real-time or near real-time to perform object detection using only 2D sensors.

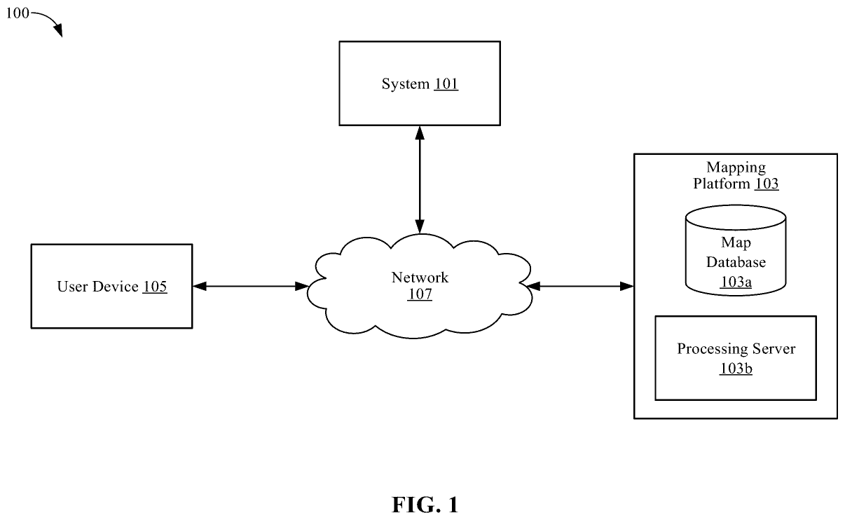

FIG. 1 illustrates a schematic diagram of a network environment 100 of a system 101 for detecting an object, in accordance with an example embodiment. The system 101 may be communicatively coupled to a mapping platform 103, and a user device 105 via a network 107. The components described in the network environment 100 may be further broken down into more than one component such as one or more sensors or application in user equipment and/or combined together in any suitable arrangement. Further, it is possible that one or more components may be rearranged, changed, added, and/or removed without deviating from the scope of the present disclosure.

In an example embodiment, the system 101 may be embodied in one or more of several ways as per the required implementation. For example, the system 101 may be embodied as a cloud-based service, a cloud based application, a remote server based service, a remote server based application, a virtual computing system, a remote server platform or a cloud based platform. As such, the system 101 may be configured to operate outside the user device 105.

In operation, the system 101 may be configured to perform near-real-time 3D feature detection for an object without the use of an explicit depth sensor (e.g. LiDAR). The system 101 may obtain, using a 2D sensor, 2D sighting data of the object. The 2D sensor may be an image sensor, such as a camera. Thus, the system 101 relies on the use of 2D sighting data of the 2D sensor only to detect the object. The object may be a road object, such as a road sign, a traffic sign, traffic cone, a speed limit sign, and the like. The 2D sighting data comprises one or more images of the road object. Based on the 2D sighting data, the system 101 determines position candidate data for the object based on (i) 2D centroid data associated with the 2D sighting data of the object and (ii) 3D centroid data determined using projection data of one or more skew lines associated with the 2D centroid data. Further, the system 101 is configured to filter the position candidate data based on: (i) offset data associated with a vector offset between the 2D centroid data and the 3D centroid data, (ii) postprocessing data, and (iii) scaling factor data associated with the position candidate data. As a result of the filtering, false positive data for the position candidates is identified and removed from the position candidate data. The remaining filtered position candidate data is used to determine the position of the object and corresponding detection data for the object at the determined position.

In one embodiment, the detection data is stored in a map database 103a of the mapping platform 103. The mapping platform 103 may use the detection data, either in real-time or by accessing stored data from the map database 103a for navigation and mapping related operations, such as generating navigation instructions, providing a map display, generating an optimized route for travel between a source location and a destination location, asset mapping and tracking, drone navigation and delivery operation, and the like.

In an embodiment, the system 101 may be communicatively coupled to the user device 105 and the mapping platform 103 via the network 107.

The mapping platform 103 may comprise the map database 103a for storing map data and a processing server 103b. The map database 103a may store node data, road segment data, link data, point of interest (POI) data, link identification information, heading value records, data about various geographic zones, regions, pedestrian data for different regions, heat maps or the like. Also, the map database 103a further includes speed limit data of different lanes, cartographic data, routing data, and/or maneuvering data. Additionally, the map database 103a may be updated dynamically to accumulate real time traffic data. The real time traffic data may be collected by analyzing the location transmitted to the mapping platform 103 by a large number of road users through the respective user devices of the road users. In one example, by calculating the speed of the road users along a length of road, the mapping platform 103 may generate a live traffic map, which is stored in the map database 103a in the form of real time traffic conditions. In an embodiment, the map database 103a may store data of different zones in a region. In one embodiment, the map database 103a may further store historical traffic data that includes travel times, average speeds and probe counts on each road or area at any given time of the day and any day of the year. In an embodiment, the map database 103a may store the probe data over a period of time for a vehicle to be at a link or road at a specific time. The probe data may be collected by one or more devices in the vehicle such as one or more sensors or image capturing devices or mobile devices. In an embodiment, the probe data may also be captured from connected-car sensors, smartphones, personal navigation devices, fixed road sensors, smart-enabled commercial vehicles, and expert monitors observing accidents and construction. In an embodiment, the map data in the map database 103a may be in the form of map tiles. Each map tile may denote a map tile arca comprising plurality of road segments or links in it. According to some example embodiments, the road segment data records may be links or segments representing roads, streets, or paths, as may be used in calculating a route or recorded route information for determination of one or more personalized routes. The node data may be ending points corresponding to the respective links or segments of road segment data. The road link data and the node data may represent a road network used by vehicles such as cars, trucks, buses, motorcycles, and/or other entities. Optionally, the map database 103a may contain path segment and node data records, such as shape points or other data that may represent pedestrian paths, links, or areas in addition to or instead of the vehicle road record data, for example. The road/link and nodes can be associated with attributes, such as geographic coordinates, street names, address ranges, speed limits, turn restrictions at intersections, and other navigation related attributes. The map database 103a may also store data about the POIs and their respective locations in the POI records. The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a may include event data (e.g., traffic incidents, construction activities, scheduled events, unscheduled events, accidents, diversions etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data.

As mentioned above, the map database 103a may be a master geographic database, but in alternate embodiments, the map database 103a may be embodied as a client-side map database and may represent a compiled navigation database that may be used in or with end user equipment such as the user device 105 to provide navigation and/or map-related functions. For example, the map database 103a may be used with the user device 105 to provide an end user with navigation features. In such a case, the map database 103a may be downloaded or stored locally (cached) on the user device 105.

The processing server 103b may comprise processing means, and communication means. For example, the processing means may comprise one or more processors configured to process requests received from the user device 105. The processing means may fetch map data from the map database 103a and transmit the same to the user device 105. In one or more example embodiments, the mapping platform 103 may periodically communicate with the user device 105 via the processing server 103b to update a local cache of the map data stored on the user device 105. Accordingly, in some example embodiments, the map data may also be stored on the user device 105 and may be updated based on periodic communication with the mapping platform 103.

In some example embodiments, the user device 105 may be any user accessible device such as a mobile phone, a smartphone, a portable computer, and the like, as a part of another portable/mobile object such as a vehicle. The user device 105 may comprise a processor, a memory, and a communication interface. The processor, the memory and the communication interface may be communicatively coupled to each other. In some example embodiments, the user device 105 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example embodiments, the user device 105 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user device 105. Additional, different, or fewer components may be provided. In one embodiment, the user device 105 may be directly coupled to the system 101 via the network 107. For example, the user device 105 may be a dedicated vehicle (or a part thereof) for gathering data for development of the map data in the database 103a. In some example embodiments, the user device 105 may serve the dual purpose of a data gatherer and a beneficiary device. The user device 105 may be configured to capture 2D sighting data associated with an object on a road which the user device 105 may be traversing. The 2D sighting data may for example be image data of road objects, road signs, or the surroundings. The 2D sighting data may refer to sensor data collected from a sensor unit in the user device 105. In accordance with an embodiment, the sensor data may refer to the data captured by a vehicle using sensors. The user device 105 may be communicatively coupled to the system 101, the mapping platform 103 over the network 107.

The network 107 may be wired, wireless, or any combination of wired and wireless communication networks, such as cellular, Wi-Fi, internet, local area networks, or the like. In one embodiment, the network 107 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an example embodiment, the system may be integrated in the user device 105. In an example, the mapping platform 103 may be integrated into a single platform to provide a suite of mapping and navigation related applications for OEM devices, such as the user devices and the system 101. The system 101 may be configured to communicate with the mapping platform 103 over the network 107.

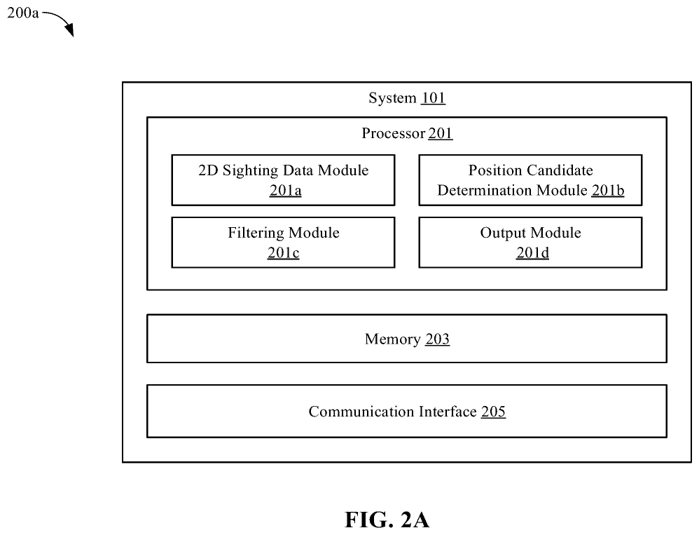

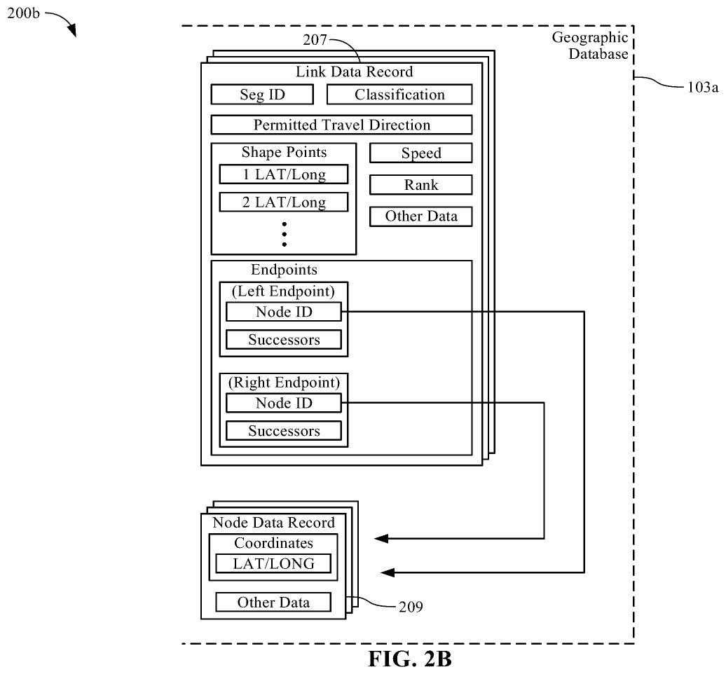

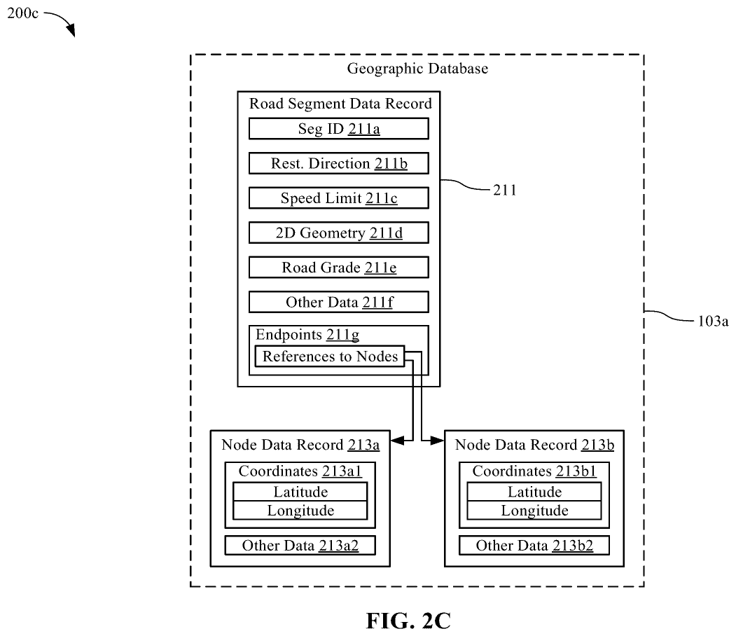

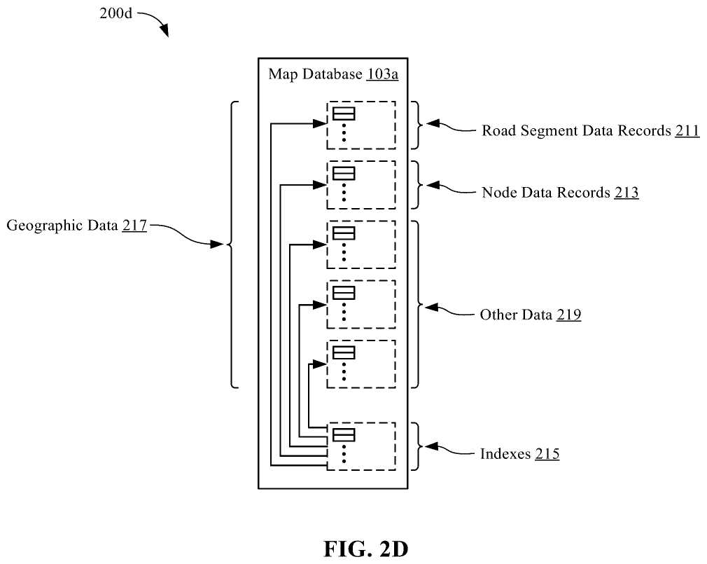

FIG. 2A illustrates a block diagram 200a of the system 101 for object detection, in accordance with an example embodiment. The system 101 may include at least one processor 201 (hereinafter, also referred to as “processor 201”), at least one memory 203 (hereinafter, also referred to as “memory 203”), and at least one communication interface 205 (hereinafter, also referred to as “communication interface 205”). The processor 201 may include a 2D sighting data module 201a, a position candidate determination module 201b, a filtering module 201c, and an output module 201d. The processor 201 may retrieve computer program code instructions that may be stored in the memory 203 for execution of the computer program code instructions.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

In some embodiments, the processor 201 may be configured to provide Internet-of-Things (IoT) related capabilities to users of the system 101. In some embodiments, the users may be or correspond to an autonomous or a semi-autonomous vehicle. The IoT related capabilities may in turn be used to provide smart navigation solutions by providing real time updates to the users to take pro-active decision on turn-maneuvers, lane changes and the like, big data analysis, traffic redirection, and sensor-based data collection by using the cloud-based mapping system for providing navigation recommendation services to the users. The system 101 may be accessed using the communication interface 205. The communication interface 205 may provide an interface for accessing various features and data stored in the system 101.

Additionally, or alternatively, the processor 201 may include one or more processors capable of processing large volumes of workloads and operations to provide support for big data analysis. In an example embodiment, the processor 201 may be in communication with the memory 203 via a bus for passing information among components coupled to the system 101.

The 2D sighting data module 201a may be configured to obtain 2D sighting data for an object, such as the road object. The 2D sighting data comprises at least polygonal object data and pose data, wherein the pose data comprises data associated with a pose of the polygonal object relative to the 2D sensor used for obtaining 2D sighting data. For example, the 2D sensor includes a camera. The camera may be used to capture image data associated with one or more objects in an environment of the user device 105. In an embodiment, when the user device 105 is installed in a vehicle, the camera captures image data of objects in the environment of the vehicle. Such objects include, for example, road objects, other vehicles, pedestrians, buildings, POIs, lane markings, terrain features, and the like.

In an embodiment, the user device 105 may be an unmanned aerial vehicle (UAV) (equivalently referred to as a “drone”), and the one or more sensors are configured to capture image data of objects detected by the UAV during a flight.

In an embodiment, the user device 105 may be a satellite and the one or more sensors are configured to capture satellite imagery of different geographical features on the earth for different geographic regions. These different geographic features include such as streets, roads, lanes, buildings, natural physical landforms like water bodies, mountains, other landforms and the like.

To that end, the 2D sighting data module 201a may be configured to acquire the 2D sensor data while a vehicle associated with the user device is driving along a road. The road may have various road objects positioned at different places. Further, a 2D polygon detector (program) may be used to detect polygonal objects in all images captured along a drive, as well as a monocular pose estimation model may be used to predict the pose relative to the camera for each polygonal object. The polygon predictions may be filtered based on a detection score. Further, in some embodiments, depth of the object is also predicted.

The position candidate determination 201b may be configured to receive data acquired by the 2D sighting data module 201a and use this data to determine position candidate data for the object. The position candidate data comprises a set of data points indicating possible positions for the object as determined from the 2D sighting data or images of the object captured by the 2D sensor. Each image includes a centroid, which is referred to as 2D centroid data. Further, 3D centroid data is determined using projection data of one or more skew lines associated with the 2D centroid data. The skew lines are back projected skew lines from each polygon centroid of the 2D centroid data. Further, the skew lines are clustered by closest distance between the skew lines. In an example, each skew line is associated to possibly multiple skew lines. This establishes position candidates. In some embodiments, monocular depth is used to bound the skew lines.

The position candidate data may be continuously accumulated for the object based on a predefined distance threshold associated with an odometrical distance value. For example, when the 2D sensor is installed in a vehicle, position candidate data is continuously accumulated until the vehicle's odometrical distance from a position candidate is lesser than or equal to the predefined distance threshold. Once all the requisite data is collected, filtering of the position candidate data is performed.

The filtering module 201c is configured to filter the position candidate data based on: (i) offset data associated with vector offset between the 2D centroid data and the 3D centroid data, (ii) postprocessing data, and (iii) scaling factor data associated with the position candidate data exceeding a set threshold. Subsequently, postprocessing and finalization of the filtered position candidate data is performed.

In an embodiment, the 2D centroid data for a 2D centroid of a polygon associated with the object, in the 2D sighting data may not coincide with the 3D centroid data for a 3D centroid for the object's projection. Thus, the offset data is determined by regressing on the vector offset of the projection of the 3D centroid from the 2D centroid, using the 2D sighting data as input. The offset data is then incorporated prior to the back projection into 3D skew lines.

In an embodiment, there are many false positives if there are multiple foreground objects in an area surrounding the object being detected, which is typically the case, as objects (especially signs and traffic signals) tend to be clustered. In particular, a skew line L1 for an object O1 might cross skew line L2 for an object O2—which may be referred to as a cross-geometric configuration, and the resulting false positive a phantom. Further, in some embodiments, determination of position candidates is sensitive to the accuracy of a monocular depth prediction model, if present. In order to overcome these challenges and inaccuracies, the position candidate data is filtered using postprocessing data. The postprocessing data comprises at least: geometric consistency data and visual appearance data, associated with the 2D sighting data of the object.

To determine the postprocessing data, for each position candidate in the position candidate data, the involved polygons are postprocessed to quadrangles. For example, for an image I contain a sighting for the current position candidate, a homographic image in I, H_I(P), of each of the other position candidates P is determined. This can be done since each position candidate contains at least two skew lines, hence a depth from each camera center or 2D sensor center may be estimated. If these skew lines indeed correspond to the same object, then the homographic images of the quadrangles in I should be geometrically consistent. Visual appearances should also be consistent, as should monocular orientation estimates. However, if there are inconsistencies in either geometry or appearance, these are detected in order to filter phantoms resulting from cross-geometric configurations. To detect geometric inconsistencies, a distribution of pairwise Intersection over Union (IoUs) between the homographic images of the quadrangles is computed, then deviation of this distribution is computed. A position candidate is rejected as a false positive if the deviation exceeds a threshold. Similarly for orientation—the slerp distance may be used to compute a distribution. For visual features, visual feature distances for each pair of homographic images are computed for the position candidate using any of the typical feature space techniques (e.g. Euclidean distance), and then a distribution is computed. However, it is observed that features tend to become less accurate with distance. Therefore, scaling factor data needs to be determined for each feature prediction associated with the object. The scaling factor data associated with the position candidate data is determined based on a distance value associated with the position candidate data, wherein the distance value is indicative of the distance of the 2D sensor from a location associated with the 2D sighting data.

In some embodiments, each feature prediction needs to be scaled by distance from position candidate as part of each distribution computation, and then filtered using the sum of the inverse-distance-scaled pairwise deviations.

In an embodiment, to determine the scaling factor data, 2D detection scores for different 2D sensors are isotonically regressed over distance to predict scaling factors for each 2D sighting data, using sighting distance and detection score as inputs to the regression model, and further using these to compute the isotonic-regressor-scaled variance. When the scaling parameters do not add up to one, they may be normalized. Then threshold based on the resulting variance associated to the position candidate is determined. For multiple features, one may take the 1_p norm (weighted by feature) across all of the feature variances, using the weighted multi-feature consistency norm. In order to determine the scaling factor, isotonic regression is preferred due to its usage for calibrating uncalibrated machine learning models. There are other possibilities: e.g. a net-based regressor, or a logistic regressor, and the like. Further, an existence likelihood is assigned to each position candidate: this may be done by reusing the normalized scaling factors from the regressor as scaling factors for the 2D detection scores for the detections associated to each position candidate. Then the existence likelihood for the position candidates is determined using the complement of the products of the scaled detection score complements.

Thus, based on the scaling factor thus determined, the position candidate data is filtered, and the filtered set is used to perform object detection.

The output module 201d is configured to determine and output the detection data for the filtered position candidate data. The scaling factor data calculated above for each sighting may be used to predict the true polygon cardinality. The prediction may be done via a voting scheme based on the distribution of cardinality frequencies weighted by the scaling factors. The maximum likelihood estimate is chosen as the predicted true cardinality. Further, the 2D sighting data which does not have the predicted polygon cardinality is discarded.

Thereafter, the 2D sighting data including polygon sightings is reprojected onto one preferred image. For real-time applications, the most recent sighting is used. However, in other scenarios, the sighting with greatest bounding polygon area is selected (distant sightings will have smaller relative area; objects viewed from a highly oblique angle will have smaller area due to the skewing effect of projection distortion).

Further constrained optimization is performed to associate polygon edges across different sightings. For example, let E1 and E2 be candidate edges from different sightings. The endpoints of edge i are denoted as E_i_d (E_i_a, E_j_a) be the reprojection distance between vertices. Let's (E_i, E_j) be the reprojected angular distance between edge orientations. Let f (E_i, E_j) be the distance between corresponding feature-vectors from the detector. Let n (E_i, E_j) be the average distance between feature-vectors of features in the neighborhood of each edge point. The cost function is: C(E_i, E_j):=alpha_1 d(E_i_1, E_j_1)+alpha_1 d(E_i_2, E_j_2)+alpha_2 s(E_i, E_j)+alpha_3 f(E_i, E_j)+alpha_4 n(E_i, E_j) for an associated pair of edges across different images E_i˜E_j. The alpha parameters are tuned. In principle, the ratio of parameters alpha_1/alpha_2 should be proportional to the distance between images, since the farther away images are, the more we trust angle as opposed to distance between vertices. Add the constraint of transitivity; if edge E_i˜E_j, then E_(i+1)˜E_(j+1). Minimize C(E_i, E_j) over all pairs of oriented edges between different images subject to the transitivity constraint. The optimal association on edges induces an association on vertices. Finally, the predicted real-world location of each vertex using multi-view triangulation is calculated and weighted by distance to object. Further, the least-squares best-fit planar patch to the predicted vertices is reconstructed for the detection data: center, orientation, width, and height of the planar patch.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to conduct various functions in accordance with an example embodiment of the present invention. For example, the memory 203 may be configured to buffer input data for processing by the processor 201.

As exemplarily illustrated in FIG. 2A, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communications to and from the user device 105 or any other component with which the system 101 may communicate. The communication interface 205 may be any means such as a device or circuitry embodied in either hardware or a combination of hardware and software that is configured to receive and/or transmit data to/from a communications device in communication with the user device 105. In this regard, the communication interface 205 may include, for example, an antenna (or multiple antennae) and supporting hardware and/or software for enabling communications with a wireless communication network. Additionally, or alternatively, the communication interface 205 may include the circuitry for interacting with the antenna(s) to cause transmission of signals via the antenna(s) or to manage receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms for enabling the system 101 to conduct information exchange functions in many different forms of communication environments. The communication interface enables exchange of information and instructions with the user device 105 and the mapping platform 103 for receiving and/or transmitting image data and navigation instructions.

FIG. 2B shows format of the map data 200b stored in the map database 103a according to one or more example embodiments. FIG. 2B shows a link data record 207 that may be used to store data about one or more of the feature lines. This link data record 207 has information (such as “attributes”, “fields”, etc.) associated with it that allows identification of the nodes associated with the link and/or the geographic positions (e.g., the latitude and longitude coordinates and/or altitude or elevation) of the two nodes. In addition, the link data record 207 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents another-than-straight road segment may include shape point data. A shape point is a location along a link between its endpoints. To represent the shape of other-than-straight roads, the mapping platform 103 and its associated map database developer selects one or more shape points along the other-than-straight road portion. Shape point data included in the link data record 207 indicate the position, (e.g., latitude, longitude, and optionally, altitude or elevation) of the selected shape points along the represented link.

Additionally, in the compiled geographic database, such as a copy of the map database 103a, there may also be a node data record 209 for each node. The node data record 209 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the associated function but excludes data and attributes that are not needed for performing the function. Thus, the map data may be alternately stored in a format suitable for performing types of navigation functions, and further may be provided on-demand, depending on the type of navigation function.

FIG. 2C shows another format of the map data 200c stored in the map database 103a according to one or more example embodiments. In the FIG. 2C, the map data 200c is stored by specifying a road segment data record 211. The road segment data record 211 is configured to represent data that represents a road network. In FIG. 2C, the map database 103a contains at least one road segment data record 211 (also referred to as “entity” or “entry”) for each road segment in a geographic region.

The map database 103a that represents the geographic region of FIG. 2A also includes a database record 213 (a node data record 213a and a node data record 213b) (or “entity” or “entry”) for each node associated with the at least one road segment shown by the road segment data record 211. (The terms “nodes” and “segments” represent only one terminology for describing these physical geographic features and other terminology for describing these features is intended to be encompassed within the scope of these concepts). Each of the node data records 213a and 213b may have associated information (such as “attributes”, “fields”, etc.) that allows identification of the road segment(s) that connect to it and/or its geographic position (e.g., its latitude and longitude coordinates).

FIG. 2C shows some of the components of the road segment data record 211 contained in the map database 103a. The road segment data record 211 includes a segment ID 211a by which the data record can be identified in the map database 103a. Each road segment data record 211 has associated with it information (such as “attributes”, “fields”, etc.) that describes features of the represented road segment. The road segment data record 211 may include data 211b that indicate the restrictions, if any, on the direction of vehicular travel permitted on the represented road segment. The road segment data record 211 includes data 211c that indicates a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 211 may also include data 211d indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 211 also includes road grade data 211e that indicates the grade or slope of the road segment. In one embodiment, the road grade data 211e includes road grade change points and a corresponding percentage of grade change. Additionally, the road grade data 211e may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 211e includes the road grade change points and an actual road grade value for the portion of the road segment after the road grade change point until the next road grade change point or end node. In a further embodiment, the road grade data 211e includes elevation data at the road grade change points and nodes. In an alternative embodiment, the road grade data 211e is an elevation model which may be used to determine the slope of the road segment.

The road segment data record 211 also includes data 211g providing the geographic coordinates (e.g., the latitude and longitude) of the end points of the represented road segment. In one embodiment, the data 211g are references to the node data records 211 that represent the nodes corresponding to the end points of the represented road segment.

The road segment data record 211 may also include or be associated with other data 211f that refer to various other attributes of the represented road segment. The various attributes associated with a road segment may be included in a single road segment record or may be included in more than one type of record which cross-reference each other. For example, the road segment data record 211 may include data identifying the name or names by which the represented road segment is known, the street address ranges along the represented road segment, and so on.

FIG. 2C also shows some of the components of the node data record 213 contained in the map database 103a. Each of the node data records 213 may have associated information (such as “attributes”, “fields”, etc.) that allows identification of the road segment(s) that connect to it and/or it is geographic position (e.g., its latitude and longitude coordinates). For the embodiment shown in FIG. 2C, the node data records 213a and 213b include the latitude and longitude coordinates 213a1 and 213b1 for their nodes. The node data records 213a and 213b may also include other data 213a2 and 213b2 that refer to various other attributes of the nodes.

Thus, the overall data stored in the map database 103a may be organized in the form of different layers for greater detail, clarity, and precision. Specifically, in the case of high-definition maps, the map data may be organized, stored, sorted, and accessed in the form of three or more layers. These layers may include road level layer, lane level layer and localization layer. The data stored in the map database 103a in the formats shown in FIGS. 2B and 2C may be combined in a suitable manner to provide these three or more layers of information. In some embodiments, there may be lesser or fewer number of layers of data also possible, without deviating from the scope of the present disclosure.

FIG. 2D illustrates a block diagram 200d of the map database 103a storing map data or geographic data 217 in the form of road segments/links, nodes, and one or more associated attributes as discussed above. Furthermore, attributes may refer to features or data layers associated with the link-node database, such as an HD lane data layer.

In addition, the map data 217 may also include other kinds of data 219. The other kinds of data 219 may represent other kinds of geographic features or anything else. The other kinds of data may include point of interest data. For example, the point of interest data may include point of interest records comprising a type (e.g., the type of point of interest, such as restaurant, ATM, etc.), location of the point of interest, a phone number, hours of operation, etc. The map database 103a also includes indexes 215. The indexes 215 may include various types of indexes that relate the different types of data to each other or that relate to other aspects of the data contained in the geographic database 103a.

The data stored in the map database 103a in the various formats discussed above may help in providing precise data for high-definition mapping applications, autonomous vehicle navigation and guidance, cruise control using ADAS, direction control using accurate vehicle manoeuvring and other such services. In some embodiments, the system 101 accesses the map database 103a storing data in the form of various layers and formats depicted in FIG. 2B, FIG. 2C and FIG. 2D. The map database 103a may additionally store the image data and the optimized model used for inference deduction that is accessed by the user device 105 for faster processing.

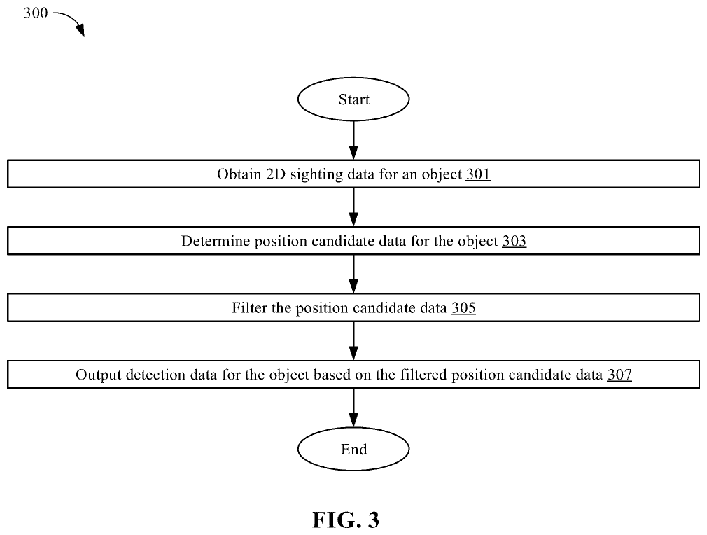

FIG. 3 illustrates a flow diagram of a method 300 for detecting an object, in accordance with an example embodiment. It will be understood that each block of the flow diagram of the method 300 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 300 illustrated by the flowchart diagram of FIG. 6 is generating an optimized model to be used in an optimized inference engine for image processing. Fewer, more, or different steps may be provided.

At 301, the method 300 comprises instructions to the 2D sighting data for the object. In an embodiment, the processor 201 may be configured to obtain the 2D sighting data associated with a 2D sensor associated with user device.

At 303, the method 300 may comprise instructions to determine position candidate data for the object. This is done on the basis of 2D centroid data associated with the 2D sighting data of the object and (3D centroid data determined using projection data of one or more skew lines associated with the 2D centroid data.

At 305, the method 300 may comprise instructions to filter the position candidate data. The filtering is done based on the offset data, the postprocessing data and the scaling factor data. The filtered position candidate data is used to assign an existence likelihood to each position candidate. This has been discussed in conjunction with FIG. 2A.

At 307, the detection data for the object is output based on the filtered position candidate data. This has been discussed in conjunction with FIG. 2A.

Accordingly, blocks of the flowchart 300 support combinations of means for performing the specified functions and combinations of operations for performing the specified functions. It will also be understood that one or more blocks of the flowchart 300, and combinations of blocks in the flowchart 300, can be implemented by special-purpose hardware-based computer systems which perform the specified functions, or combinations of special-purpose hardware and computer instructions.

In some embodiments, the system 101 may comprise means for performing each of the operations described above in conjunction with method 300. In this regard, according to an example embodiment, examples of means for performing operations may comprise, for example, the processor and/or a device or circuit for executing instructions or executing an algorithm for processing information as described above.

Using the system 101 and the method 300, accurate and faster real-time processing of object detection data may be done. 2D detections may be streamed in from sequential images. Then (1) position candidates are filtered from memory if the vehicle has gone along the road far enough, and (2) existing position candidates are updated with new 2D detections and associated postprocessed data (e.g. skew lines, quadrangles, etc) and a state associated to the position candidate which determines whether it's real or a phantom at the current time is updated.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

I/we claim:

1. A system for detecting an object, comprising:
at least one non-transitory memory configured to store computer-executable instructions; and
at least one processor configured to execute the computer-executable instructions to:
obtain, using a 2D sensor, 2D sighting data of the object;
determine position candidate data for the object based on (i) 2D centroid data associated with the 2D sighting data of the object and (ii) 3D centroid data determined using projection data of one or more skew lines associated with the 2D centroid data;
filter the position candidate data based on: (i) offset data associated with vector offset between 2D centroid data and the 3D centroid data, (ii) postprocessing data, and (iii) scaling factor data associated with the position candidate data; and
output detection data for the object based on the filtered position candidate data.

2. The system of claim 1, wherein the 2D sighting data comprises at least polygonal object data and pose data, wherein the pose data comprises data associated with a pose of the polygonal object relative to the 2D sensor used for obtaining 2D sighting data.

3. The system of claim 1, wherein the at least one processor is further configured to determine the position candidate data for the object based on a predefined distance threshold associated with an odometrical distance value.

4. The system of claim 1, wherein the at least one processor is further configured to cluster the one or more skew lines based on a closest distance between the one or more skew lines.

5. The system of claim 1, wherein the postprocessing data comprises at least: geometric consistency data and visual appearance data, associated with the 2D sighting data of the object.

6. The system of claim 1, wherein the scaling factor data associated with the position candidate data is determined based on a distance value associated with the position candidate data, wherein the distance value is indicative of the distance of the 2D sensor from a location associated with the 2D sighting data.

7. The system of claim 1, wherein the object comprises a road object.

8. The system of claim 1, wherein the detection data comprises a predicted polygon cardinality for the filtered position candidate data.

9. The system of claim 1, wherein the at least one processor is further configured to update a map database based on the detection data.

10. The system of claim 1, wherein the at least one processor is further configured to generate a navigation instruction based on the detection data.

11. The system of claim 1, wherein the 2D sensor comprises a camera.

12. A method for detecting an object comprising:
obtaining, using a 2D sensor, 2D sighting data of the object;
determining position candidate data for the object based on (i) 2D centroid data associated with the 2D sighting data of the object and (ii) 3D centroid data determined using projection data of one or more skew lines associated with the 2D centroid data;
filtering the position candidate data based on: (i) offset data associated with vector offset between the 2D centroid data and the 3D centroid data, (ii) postprocessing data, and (iii) scaling factor data associated with the position candidate data; and
outputting detection data for the object based on the filtered position candidate data.

13. The method of claim 12, wherein the 2D sighting data comprises at least polygonal object data and pose data, wherein the pose data comprises data associated with a pose of the polygonal object relative to the 2D sensor used for obtaining 2D sighting data.

14. The method of claim 12, further comprising determining the position candidate data for the object based on a predefined distance threshold associated with an odometrical distance value.

15. The method of claim 12, further comprising clustering the one or more skew lines based on a closest distance between the one or more skew lines.

16. The method of claim 12, wherein the postprocessing data comprises at least: geometric consistency data and visual appearance data, associated with the 2D sighting data of the object.

17. The method of claim 12, wherein the scaling factor data associated with the position candidate data is determined based on a distance value associated with the position candidate data, wherein the distance value is indicative of the distance of the 2D sensor from a location associated with the 2D sighting data.

18. The method of claim 12, wherein the object comprises a road object.

19. The method of claim 12, further comprising updating a map database based on the detection data.

20. A non-transitory computer-readable medium having stored thereon computer-executable instructions, which when executed by a computer, cause the computer to execute operations, the operations comprising:
obtaining, using a 2D sensor, 2D sighting data of the object;
determining position candidate data for the object based on (i) 2D centroid data associated with the 2D sighting data of the object and (ii) 3D centroid data determined using projection data of one or more skew lines associated with the 2D centroid data;
filtering the position candidate data based on: (i) offset data associated with vector offset between the 2D centroid data and the 3D centroid data, (ii) postprocessing data, and (iii) scaling factor data associated with the position candidate data; and
outputting detection data for the object based on the filtered position candidate data.
